(19) United States
(12) Patent Application Publication
(10) Pub. No.: US 2020/0161889 A1
(43) Pub. Date: May 21, 2020

(54) OVER-THE-AIR WIRELESS CHARGING

(71) Applicant: T-Mobile USA, Inc., Bellevue, WA (US)

(72) Inventor: Wei-Ming Lan, Newcastle, WA (US)

(21) Appl. No.: 16/194,106

(22) Filed: Nov. 16, 2018

(51) Int. Cl. H02J 7/02; H02J 50/80; H02J 50/90; H02J 50/20

(52) U.S. Cl. CPC H02J 7/025; H02J 50/80; H04W 4/20; H02J 50/20; H02J 50/90

(57) ABSTRACT

This disclosure describes techniques for charging multiple heterogenous user equipment over-the-air at a mass scale. The techniques involve utilizing one or more dedicated radio frequency (RF) sources such as charging stations that include transmitters for transmitting RF energy to one or more user equipment including receiver components. The user equipment is configured to convert the RF energy into direct current (DC) power so as to allow the transmitters to provide power on demand for a number of close range wireless user equipment.

### BACKGROUND

Wireless charging is becoming the new norm for many mobile devices. Wireless charging is a technology that allows charging over short distances without cables. Typically, wireless charging involves using a wireless charging pad on which a user can simply place his or her user equipment. While there are various competing standards for wireless charging, the most popular is Qi™, which is supported by most mobile devices, namely, smart phones. The advantage of wireless charging is that it is more convenient than the traditional method of using charging cables as a user is not required to plug and unplug a user equipment each time the user interrupts charging. However, these charging pads comprise a cable that must be connected to a power source such as a wall outlet. Accordingly, the charging pads do not provide a truly wireless method of charging user equipment that would enable users to have freedom of placement and mobility during charging and usage.

Additionally, user equipment needs to be positioned or aligned correctly atop charging pads in order to receive power delivered using inductive coupling between two coils embedded within the charging pads. Because the user equipment needs to make contact with the charging pads to receive power, the charging pads still limit the usage of user equipment during charging and a user cannot use the user equipment easily. The inductive wireless charging also lags behind quick-charge cables. Therefore, charging pads lack significant benefits over traditional charge cables.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates example architecture for remotely charging multiple devices over-the-air.

FIG. 2 is a block diagram showing various components of one or more wireless charging transmitters and wireless charging receivers.

FIG. 3 is a block diagram showing various components of one or more computing devices that is configured to provide an application for receiving predefined criteria for prioritizing user equipment for over-the-air charging.

FIG. 4 is a flow diagram of an example process for charging multiple user equipment over-the-air.

FIG. 5 is a flow diagram of an example process for receiving predefined criteria for prioritizing user equipment for over-the-air charging.

### DETAILED DESCRIPTION

This disclosure is directed to techniques for remotely charging multiple heterogeneous user equipment or electronic devices over-the-air in an urban environment. Charging multiple user equipment requires managing various charging protocols that apply to each battery-operated user equipment. The charging protocol can include the amount of voltage or current made available to a battery being charged, the amount of time it takes for a battery to be fully charged, a battery's charge rate or discharge rate, what to do when charging is complete, and/or so forth. The charging protocol typically depends on the size and the type of battery being charged. Simple chargers or fast chargers typically serve a single user equipment at a time. Additionally, these chargers are configured to accommodate specific user equipment. Some induction chargers can serve multiple user equipment at a time using a wireless charging standard such as Qi™ These charging devices need to be physically coupled with user equipment in order to detect the condition of its battery and the state of charge, however.

The techniques described herein streamline the charging process for heterogeneous user equipment while managing various charging protocol. In various embodiments, the present system comprises one or more charging stations, each charging station having a transmitter component that provides radio frequencies (RF) to power nearby user equipment. More specifically, the charging station can broadcast RF energy to multiple nearby user equipment that rely on battery-based systems. The user equipment can harvest the broadcasted RF energy to convert it into electrical power, thereby eliminating or reducing the need for battery replacement or extending the operating life of systems using rechargeable batteries. The charging stations can transmit RF energy on a room-by-room basis or on a floor-by-floor basis. Additionally, each charging station can serve multiple user equipment and a single user equipment can use multiple charging stations, depending upon embodiments. Preferably, a coverage area provided by one charging station can partially overlap with one or more coverage areas provided by other charging stations. In this way, the charging stations can ensure freedom of placement and mobility during charging and usage. Additionally, the charging stations can be confined to a specific space or a region. For example, a single region can comprise multiple floors in a floor plan. In another example, the charging station can be located in a vehicle or a room to charge multiple user equipment located within the vehicle or the room. It is noted that the charging techniques described herein are not limited to the use of radio frequency. For example, ultrasound, microwave, resonant and inductive magnetic fields, laser, infrared (IR) and/or other wave transmission techniques that involve converting transmitted energy into electrical power can be used.

Smart charging techniques can also be applied in order to monitor each of the user equipment's battery voltage, temperature, or time under charge to determine the optimum charge current and to terminate charging in accordance with each of the user equipment's charging protocols. In this regard, the charging stations can detect a presence of one or more user equipment, the condition of their respective batteries and a corresponding state of charge in order to prioritize the order in which each of the one or more user equipment(s) should be charged. Additionally, or alternatively, the charging stations can serve specific user equipment upon receiving from the user equipment a request for direct transmission of RF power.

The user equipment can utilize a web-based and/or a client-based application to manually input charging preferences or protocol to provide charging, depending upon embodiments. The application can comprise graphical user interface (GUI) components in which information is displayed to a user and/or from which user input is received. A user can connect one or more user equipment with a charging station by entering target user equipment identification for each of the user equipment. Upon connection, the target user equipment can automatically upload its voltage data in order for the charging station to determine appropriate power transmission signals for the user equipment. Thereafter, a user can input charging preferences for each connected user equipment. For example, the charging preferences can comprise maximum charge limit, delayed charging, location-based charging, and/or so forth. In response to user input, the charging station selectively charges the user equipment in accordance with the parameters set for each of the user equipment. The techniques described herein may be implemented in a number of ways. Example implementations are provided below with reference to the following figures.

### Example Architecture

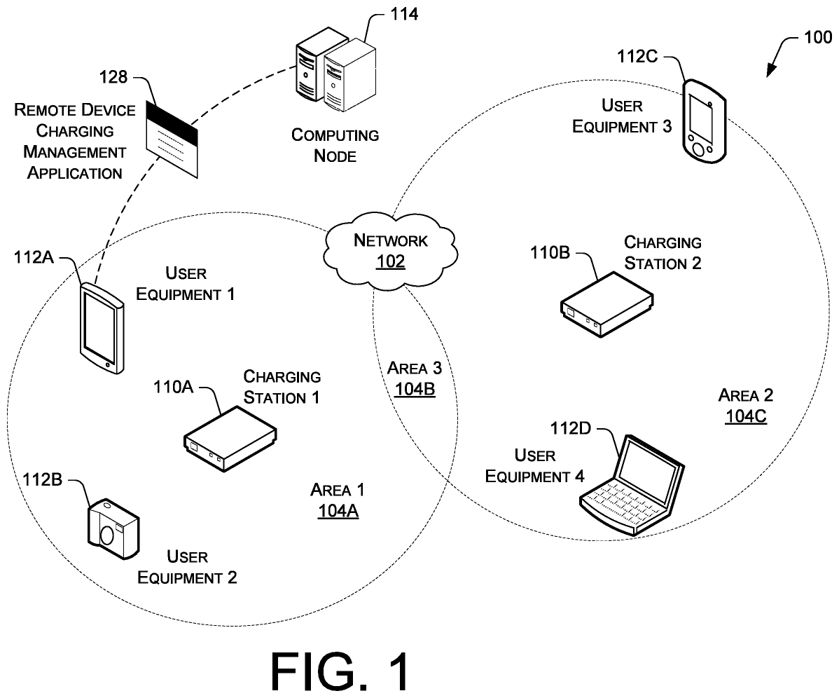

FIG. 1 illustrates example architecture for a system 100 for remotely charging multiple devices over-the-air, in accordance with some embodiments. In this example, the system 100 implements one or more charging stations 110A, 110B in communication with one or more user equipment 112A-112D in a network 102. Each of the charging stations 110A, 110B comprises at least one RF transmitter component that is configured to transmit a radio wave and modulate that wave to carry power transmission signals to the one or more user equipment 112A-112D. Preferably, the charging stations 110A, 110B are deployed at various locations in public venues or other urban environments to serve a number of user equipment 112A-112D concurrently. Thus, each of the RF transmitter components of the charging stations 110A, 110B can handle multiple user equipment 112A-112D comprising receiver components, whereby the receiver components can convert the power transmission signals into electrical power.

It is noted that the charging stations 110A, 110B can be configured to emit only specific RF signals that are within a permitted frequency range. For example, RF energy can be broadcasted in one or more unlicensed bands as more power or more predictable energy is needed than what is currently available. The charging stations 110A, 110B can communicate with a database 106 of regulations to determine the types of RF signals that it is permitted to transmit under the applicable broadcasting rules and regulations.

The energy carried by radio frequency transmissions from each of the charging stations 110A, 110B is in the air within the coverage areas 104A-104C. The coverage area 104A-104C is substantially a circle of a predetermined radius (e.g., 80 meters) around one or more antennae of each of the charging station 110A, 110B. It is noted that the range can depend on the transmitting power of the charging station and the antenna used for harvesting RF energy from charging stations. Accordingly, the user equipment 112A-112D can receive power transmission signals while in the coverage area 104A, 104C. Preferably, the charging stations 110A, 110B can be located so that the coverage areas at least partially overlap 104B to reduce or eliminate any interruptions when charging the user equipment 112A-112D. It is noted, however, that two or more coverage areas may be non-overlapping. The charging stations 110A, 110B can provide power on a room-by-room basis or by regions, wherein the regions can be a single room, an area including multiple rooms that may or may not be adjacent to each other, and/or across multiple floors in a floor plan. Thus, the regions can be arbitrarily defined as needed.

In an example embodiment, the charging stations 110A, 110B are configured to detect user equipment 112A-112D that are located within a predetermined coverage area 104A-104C to transmit RF signals to the user equipment 112A-112D. The user equipment 112A-112D can comprise various types of mobile devices. The user equipment 112A-112D may include a personal computer, mobile handsets, smartphones, tablet computers, personal digital assistants (PDAs), cameras, wearable electronic devices such as smart watches and medical devices, and/or other electronic devices executing conventional web browser applications, or applications that have been developed for a specific platform (e.g., operating system, computer system, or some combination thereof) and that are capable of receiving inputs, processing the inputs, and generating output data. The user equipment 112A-112D can comprise battery-based systems and/or systems that can be hardwired.

Each of the user equipment 112A-112D comprises a receiver component to receive power transmission signals from the charging stations. Because the coverage areas 104A 104C can overlap 104B, the user equipment 112A-112D can detect multiple charging stations 110A, 110B from a single location. Upon detecting one or more charging stations 110A, 110B, the user equipment 112A-112D automatically connects to the nearest charging station 110A, 110B, or the charging station 110A, 110B that provides the strongest RF signal transmission for most optimal charging. Preferably, the user equipment 112A-112D can be charged out-of-box without the need for installing software and no pairing is required. In this regard, various automatic connection initiation techniques can be used (e.g., low energy chips, modifying a charging device's friendly name to the activation code, etc.)

The user equipment 112A-112D can receive power over-the-air while located within the coverage area 104A-104C at varying speeds. For instance, the charging speed increases as the user equipment 112A-112D moves closer to the charging station 110A, 110B to which it is connected. Conversely, the charging speed decreases as the user equipment 112A-112D moves further away from the charging station 110A, 110B to which it is connected. If the user equipment 112A-112D moves a predetermined distance away from a first charging station 110A and is within a predetermined distance to a second charging station 110B, the user equipment 112A-112D automatically disconnects from the first charging station 110A and connects to the second charging station 110B. Thus, the user equipment 112A-112D can establish a connection to different charging stations 110A, 110B as the location of the user equipment 112A-112D changes within the coverage areas 104A-104C. If the user equipment 112A-112D is not within the coverage areas 104A-104C, the user equipment 112A-112D can receive alerts or notifications (i.e., via a user interface) from one or more charging stations 110A, 110B that the user equipment 112A-112D is not within the coverage areas 104A-104C and not being charged. Additionally, if the user equipment 112A-112D is within a predetermined distance away from the coverage area boundaries, the user equipment 112A-112D can receive alerts or notifications from one or more charging stations 110A, 110B that the charging may be interrupted.

In various embodiments, the first charging station 110A can pass off or reassign the user equipment 112A-112D to the second charging station 110B to optimize the charging station resource use and/or to avoid overload of any single charging station. Similarly, if the user equipment 112A-112D is an equal distance away from a first charging station 110A and a second charging station 110B, the user equipment 112A-112D connects to the charging station that would most optimize the charging station resource use and/or to avoid overload of any single charging station. In this way, the user equipment 112A-112D can charge at the most optimal rate.

Additionally, multiple user equipment 112A-112D can charge simultaneously. In various embodiments, the charging stations 110A, 110B can target user equipment 112A-112D with low power appetites. Without limitation, low power devices include wearable electronic devices. It is contemplated that these low power devices can also receive power at greater distances. The charging stations 110A, 110B can also target user equipment 112A-112D based at least partially on device type (e.g., hardware), device identification, device compatibility, and/or so forth. For example, the charging stations 110A, 110B can target specific device types served by a wireless communication carrier.

In various embodiments, the system 100 further includes one or more computing nodes 114 (e.g., servers) for managing the operation of the charging stations 110A, 110B via an application. For example, the computing node 114 is configured to execute a remote device charging management application 128. The one or more computing nodes 114 may include general-purpose computers, such as desktop computers, tablet computers, laptop computers, servers, or other electronic devices that are capable of receiving inputs, processing the inputs, and generating output data. In still other embodiments, the one or more computing nodes 114 may be virtual computing devices in the form of computing nodes, such as virtual machines and software containers.

In various embodiments, a wireless telecommunication carrier that provides the wireless telecommunication network, and/or a third-party entity that is working with the wireless telecommunication carrier may control the computing nodes 114. The one or more computing nodes 114 may store data in a distributed storage system, in which data may be stored for long periods of time and replicated to guarantee reliability. Accordingly, the one or more computing nodes 114 may provide data and processing redundancy, in which data processing and data storage may be scaled in response to demand. Further, in a networked deployment, one or more computing nodes 114 may be added or removed without affecting the operational integrity of the remote device charging management application 128 and the charging stations 110A, 110B.

The user equipment 112A-112D can execute a software application to log onto the one or more computing nodes 114 and input criteria for charging the user equipment 112A-112D. The remote device charging management application 128 comprises a computer program for supporting and managing custom battery and power settings for user equipment 112A-112D. The remote device charging management application 128 can be a native software program that resides locally in whole or in part on one or more user equipment 112A-112D. Additionally, or alternatively, the remote device charging management application 128 can be a cloud-based application that relies on the one or more remote computing nodes 114. In various embodiments, the remote device charging management application 128 comprises an application user interface (e.g., graphical user interface (GUI)) for connecting the user equipment 112A-112D to the charging stations 110, 11B and launching the battery and power plan options for each connected user equipment 112A-112D.

In this regard, a user can input data associated with each of the user equipment 112A-112D, including device identification, device type, and/or other types of relevant data. Upon receiving user input, the remote device charging management application 128 can automatically determine voltage data or other relevant metrics such as a battery's state-of-charge (SoC) for each of the user equipment 112A-112D to enable connected charging stations 110A, 110B to transmit power transmission signals. For instance, the charge current can be lowered after the battery reaches a predetermined percent SoC. Additionally, a user can manually input charging parameters or protocol to customize and manage battery and power settings for each connected user equipment 112A-112D. For example, the user can specify preferences for time-based charging, device-based charging, user-based charging, location-based charging, maximum charge limit, delayed charging, and/or so forth. Accordingly, each charging station 110A, 110B can serve multiple user equipment to charge multiple devices simultaneously at varying speeds (i.e., by transmitting different charge currents or different voltages).

The GUI of the remote device charging management application 128 can also provide a dashboard and/or tools (not pictured) for display. For example, the GUI can display the battery status for each of the user equipment 112A-112D and indicate if the user equipment 112A-112D is currently connected to a charging station 110A, 110B and be charging its battery. In various embodiments, the dashboard can comprise a dialogue box that can ask a user of the connected user equipment 112A-112D to select a power plan option that best matches his or her current activities for each of the user equipment 112A-112D.

For example, the power plan options can provide different battery modes such as a “high performance mode” for utilizing the user equipment's battery at its maximum power, a “balanced performance mode,” for utilizing the user equipment's battery at a default setting, and a “power saver mode” for utilizing the user equipment's battery at its minimum power. These features may be switched on and off by user command via the GUI. A user can select “high performance” in the dialogue box if his or her user equipment is connected to a charging station 110A, 110B and the battery is charging. The user can select a “balanced performance mode” if the user does not need to save power and the user wants to optimize the user equipment's 112A-112D power settings. The user can also select “power saver mode” if the user needs to run the user equipment 112A-112D on only battery power for as long as possible. Upon receiving a selection for a power plan option, the charging station 110A, 110B can prioritize the order in which power transmission signals can be transmitted to each of the user equipment 112A-112D. In one embodiment, the charging station 110A, 110B can be configured to target the user equipment 112A-112D that is in a “power saver mode” first to serve user equipment 112A-112D with the lowest SoC.

In various embodiments, the remote device charging management application 128 can be configured to analyze each of the user equipment's usage schedule or usage pattern (i.e., battery usage pattern) as well as charging pattern. More specifically, the remote device charging management application 128 can monitor usage of the user equipment 112A-112D for a predetermined amount of time and implement machine learning algorithms for learning usage patterns of the user with respect to the user equipment 112A-112D. Thus, the remote device charging management application 128 determines when a user equipment 112A-112D is most used and least used. In various embodiments, the charging station 110A, 110B can automatically begin charging connected user equipment 112A-112D when the user equipment 112A-112D is likely not in use to optimize the battery's charging speed and to minimize interference with the usage of the user equipment 112A-112D.

In various embodiments, the charging stations 110A, 110B can comprise a fee structure. For example, a user can charge at a charging station 110A, 110B with a fee structure. In various embodiments, charging stations 110A, 110B can provide a free charging period that switches to a fee after a predetermined amount of time, and access to charging can be denied until a user associates payment. In this regard, a user can add one or more payment methods with a user account created via the remote device charging management application 128, wherein the user account can be associated with the user equipment and one or more users.

### Example Transmitter and Receiver Components

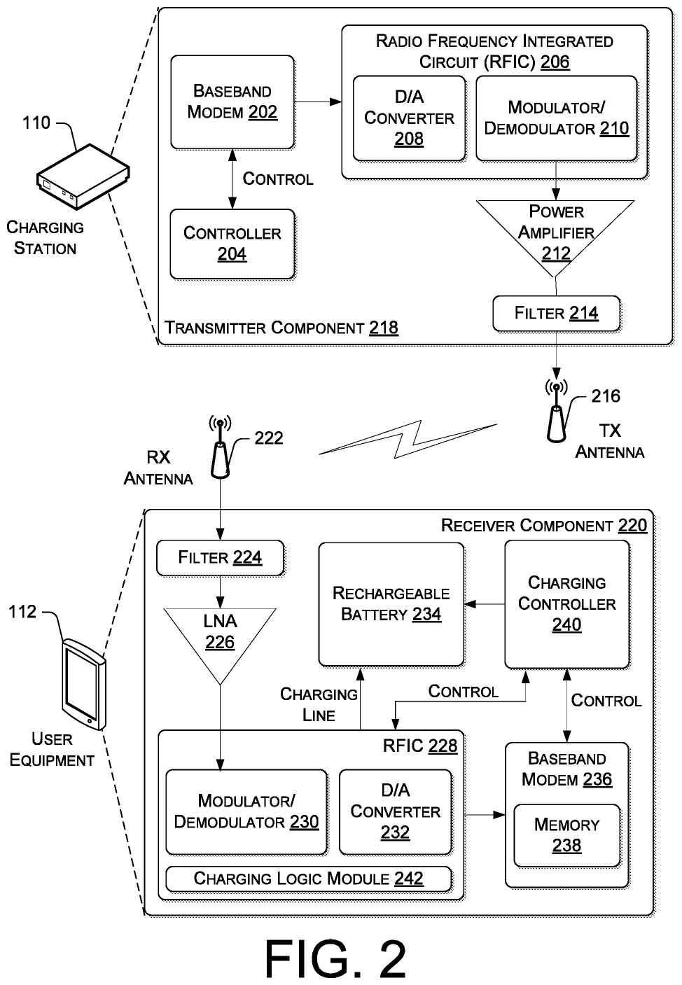

FIG. 2 is a block diagram showing various components of one or more wireless charging stations 110 and user equipment 112. It is noted that the charging station 110 and the user equipment 112 as described herein can operate with more or fewer of the components or modules shown herein. Additionally, the charging station 110 and the user equipment 112 as shown herein or portions thereof can serve as a representation of the one or more of the charging stations 110 and the user equipment 112 of the present system.

The charging station 110 comprises a transmitter component having a baseband modem 202 that is operatively connected to a controller 204 (e.g., a micro controller or other suitable types of processing unit) and a radio frequency integrated circuit (RFIC) 206. The baseband modem 202 is configured to provide baseband and/or intermediate frequency signals and may be operated according to multiple mobile communication access protocols (i.e., multi-mode), and thus may be configured to support one or more of LTE, UMTS, and/or GSM access protocols. In this regard, the baseband modem 202 can comprise a wireless modem such as a long-term evolution (LTE) modem or any other suitable devices for facilitating communications between the charging station 110 and an access network, or any combination thereof. In an example embodiment, the wireless communication network can comprise an LTE network. Although not explicitly shown, the baseband modem 202 can include components such as digital processing circuits or one or more digital processing circuits, a processor, and a memory, depending upon embodiments.

The controller 204 can include a machine-readable medium on which is stored one or more sets of data structures and/or instructions embodying or utilized by any one or more of the methodologies or functions described herein. The instructions can also reside, completely or at least partially within the controller 204 during execution thereof by the controller 204. Thus, the controller 204 can also constitute machine-readable media. The controller 204 provides data to the baseband modem 202, wherein the data specifies the type of power signals that can be transmitted to the user equipment 112 and converted into a source of electrical energy. The controller 204 is configured to handle radio data packetization or manage a protocol such as an IEEE 802.15.4 compliant module. In various embodiments, one or more logic circuits, processors, microprocessors, microcontrollers, scalar processors, vector processors, central processing units (CPU), graphics processing units (GPU), digital signal processors (DSP), field programmable gate arrays (FPGA), integrated circuits, application specific integrated circuits (ASICS), etc., or any combinations thereof can be used in lieu of the controller 204.

In the illustrated embodiment, the RFIC 206 comprises a digital-to-analog (D/A) converter 208 and a combined modulator/demodulator 210. The combined modulator/demodulator 210 is configured to receive a baseband input signal and output a radio frequency modulated signal or power transmission signal. The combined modulator/demodulator 210 can also extract any information that is modulated onto a carrier wave from the carrier wave itself. The combined modulator/demodulator 210 can input power transmission signals onto a power transmission wave at the transmitter component (i.e., the transmitter end) for processing on the user equipment 112 (i.e., the receiver end). Various types of signal modulation methods can be used in RF transmitter and receiver components, including amplitude-shift keying (ASK), on-off keying (OOK), frequency-shift keying (FSK), direct-sequence spread spectrum, and frequency-hopping spread spectrum. In various embodiments, the RFIC 206 can also include phase shifters (not pictured), wherein the phase shifters can provide a controllable phase shift of the RF signal and can be programmed by the controller 204 to implement charging algorithms.

The charging algorithms allow the charging station 110 to control the voltage that is applied to a battery of connected user equipment 112, the amount of charge current that is made available to the battery of the user equipment 112, and the timing of the voltage and current amounts to co-exist. The combined modulator/demodulator 210 is further connected to a power amplifier (PA) 212, which is connected to a filter 214. The PA 212 reproduces low-power signals at a level that is strong enough for charging user equipment 112 or for increasing the ability to transmit signals to user equipment 112. The filter 214 is coupled to an antenna 216 (i.e., TX antenna). The antenna 216 can comprise an omnidirectional antenna. The filter 214 can filter signals so that the transmitted signals comprise signals at the desired bandwidth range.

The charging station 110 is connected to user equipment 112 having a receiver component 220. The transmitter component 218 and the receiver component 220 can communicate according to various wireless standard and wireless protocol generally used in RF modules, including Zigbee, Bluetooth low energy, Wi-Fi, IEEE 802.15.4, Z-Wave, and/or so forth. The user equipment 112 comprises a variety of mobile devices that can rely on rechargeable batteries. The receiver component includes an antenna 222 (i.e., RX antenna) that is connected to a filter 224. The antenna 222 can comprise an omnidirectional antenna. The filter 224 removes interference signals such as signals from nearby RF sources that are not charging stations 110. The filter 224 is connected to a low noise amplifier (LNA) 226 for amplifying signals received from the charging station 110. The LNA 226 is connected to an RFIC 228, which comprises a modulator/demodulator 230 and a D/A converter 232. In various embodiments, the RFIC 228 can comprise a machine-readable media having a charging logic module 242 stored thereon. The machine-readable media can comprise a memory and/or a processor. The charging logic module 242 can be stored in the memory and/or within the processor during execution thereof.

The RFIC 228 is further connected to a rechargeable battery 234 and a charging controller 240 (e.g., a micro controller or other suitable types of processing unit). The rechargeable battery 234 comprises a lead-acid battery, nickel-cadmium (NiCd) battery, nickel-metal hydride (NiMH) battery, lithium-ion, lithium polymer battery, and/or so forth. The charging logic module 242 determines a charge current for charging the rechargeable battery 234 from the charging station 110 based on a voltage range of the rechargeable battery 234. For example, the charging logic module 242 can set the charge current for charging the battery 234 to be less than the excess current available from the charging station 110. In various embodiments, the charging logic module 242 can also control the charging station 110 to charge the battery 234 with the charge current by specifying the charge current to the charging station 110. In response, the charging station 110 can reduce the current used for charging the battery 234 to a level equal to the charge current. The charging logic module 242 can set the charge current for charging the battery 234 based at least partially on the temperature of the battery 234, the voltage of the battery 234, the age of the battery 234, battery impedance, and/or other relevant factors.

The RFIC 228 and the charging controller 240 are connected to a baseband modem 236. As noted herein, the baseband modem 236 can comprise a machine-readable medium on which is stored one or more sets of data structures and instructions (e.g., software) embodying or utilized by any one or more of the methodologies or functions described herein. The instructions may also reside, completely, or at least partially, within a memory unit 238 that can be integral to the baseband modem 236 during the execution of the user equipment. In some embodiments, the charging logic module 242 can be stored at least partially in the memory 238 and executed via the charging controller 240. The charging controller 240 can also constitute machine-readable media. It is noted that the charging station 110 and the user equipment 112 can comprise transceiver components that will provide the functionality of a transmitter component 218 and a receiver component 220, depending upon embodiments. Additionally, the charging station 110 and the user equipment 112 can comprise a system on a chip module. The system on a chip module can comprise an onboard microcontroller and operate similarly to the transceiver module.

### Example Computing Device Components

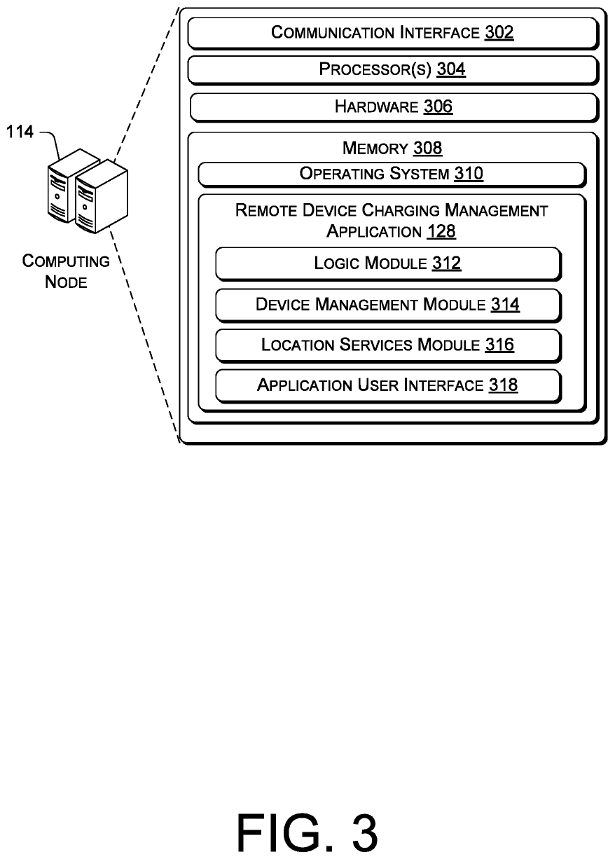

FIG. 3 is a block diagram showing various components of one or more illustrative computing devices comprising one or more computing nodes 114 that can provide a remote device charging management application 128. It is noted that the computing device(s) as described herein can operate with more or fewer of the components shown herein. Additionally, the computing device(s) as shown herein or portions thereof can serve as a representation of the one or more of the computing devices of the present system.

The one or more computing nodes 114 is in communication with one or more user equipment. In this regard, the one or more computing nodes 114 may include a communication interface 302, one or more processor(s) 304, hardware 306, and a memory unit 308. The communication interface 302 may include wireless and/or wired communication components that enable the one or more computing nodes 114 to transmit data to and receive data from other networked devices. In at least one example, the one or more processor(s) 304 may be a central processing unit(s) (CPU), graphics processing unit(s) (GPU), a both a CPU and GPU, or any other sort of processing unit(s). Each of the one or more processor(s) 304 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution. The one or more processor(s) 304 may also be responsible for executing all computer applications stored in the memory, which can be associated with common types of volatile (RAM) and/or nonvolatile (ROM) memory. The hardware 306 may include additional hardware interface, data communication, or data storage hardware. For example, the hardware interfaces may include a data output device (e.g., visual display, audio speakers), and one or more data input devices (e.g., keypads, keyboards, mouse devices, touch screens that accept gestures, microphones, voice or speech recognition devices, etc.).

The memory unit 308 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or another transmission mechanism.

The processor 304 and the memory unit 308 may implement an operating system 310. The operating system 310 may provide an execution environment for the remote device charging management application 128. Additionally, the operating system 310 may include other components that perform various additional functions generally associated with an operating system. For example, the operating system 310 may include components that enable the one or more computing nodes 114 to receive and transmit data via various interfaces (e.g., user controls, communication interface, and/or memory input/output devices), as well as process data using the processors 304 to generate output. The operating system 310 may include a presentation component that presents the output (e.g., display the data on an electronic display, store the data in memory, transmit the data to another electronic device, etc.).

The remote device charging management application 128 comprises a logic module 312, a device management module 314, location services module 316, and an application user interface 318 that comprises GUI components. The device management module 314 is configured to manage the demands of each of the connected user equipment and distribute power supply. In one embodiment, the device management module 314 is configured to add a new user equipment to connect to a charging station, remove connected user equipment or decommissioned user equipment, and/or replace a connected user equipment with another user equipment. In this regard, the device management module 314 is configured to receive unique target user equipment identification, via a user at the application user interface 318, for each of the user equipment to connect with a charging station. Upon connection, the device management module 314 can receive charging protocol and/or customized charging parameter (e.g., time-based charging, device-based charging, user-based charging, etc.) for each of the connected user equipment. For instance, the device management module 314 can query a user for a target user equipment's voltage data. Alternatively, the target user equipment can automatically upload its voltage data and any related data in order for the charging station to transmit appropriate power transmission signals for the user equipment.

The logic module 312 is configured to determine power requirement for each of the user equipment based at least partially on a voltage range of the user equipment's battery, the age of the battery, battery impedance, the temperature of the battery, or any combination thereof. Additionally, the logic module 312 is configured to determine the power output capacity of a charging station. In this way, the logic module 312 can set the charge current for charging the battery to be less than the excess current available from the charging station. In various embodiments, the logic module 312 is configured to set the charge current for charging the battery based on the power plan option selected for the user equipment. In this way, the logic module 312 can control the battery charging process by targeting the user equipment mode with the lowest SoC (i.e., the least amount of power supply). Upon determining a charge current via the logic module 312, the device management module 314 can trigger the charging stations to transmit power transmission signals.

The location services module 316 is configured to track a real-time location of each of the connected user equipment to determine whether the user equipment is in the coverage area to receive power transmission signals from one or more connected charging stations. In this way, the location services module 316 can instruct the charging station to charge the user equipment when the user equipment is located in the coverage area. It is contemplated that various tracking techniques that include global positioning system (GPS), Wi-Fi, Bluetooth low energy, and/or radio-frequency identification (RFID) can be employed.

### Example Processes

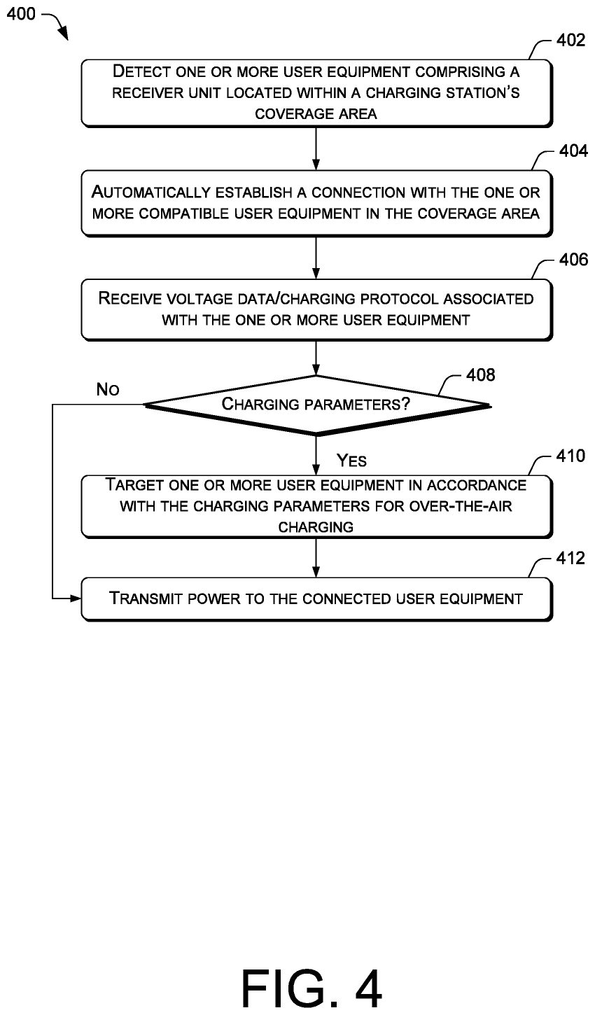

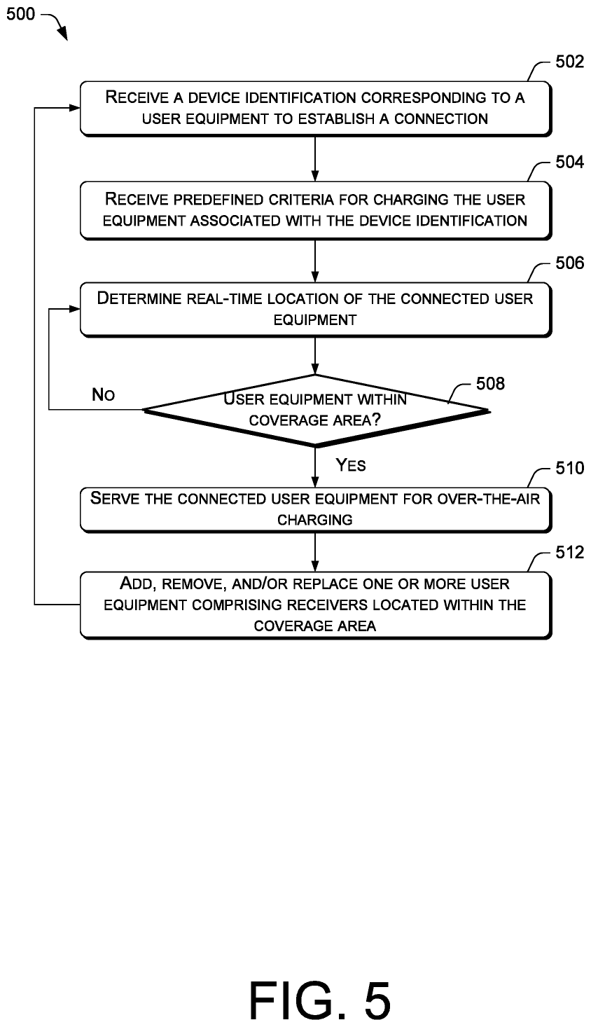

FIGS. 4-5 present illustrative processes 400-500 for using one or more transmitters to conduct over-the-air charging for user equipment on a mass scale. Each of the processes 400-500 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes of 400-500 are generally described with reference to the architecture 100 of FIG. 1.

FIG. 4 is a flow diagram of an example process 400 for charging multiple user equipment over-the-air from the perspective of one or more charging stations, each charging station serving a coverage area. At block 402, the charging station, via its RF transmitter component, detects the presence of one or more user equipment comprising a receiver unit located within a predetermined radius of a transmitter (i.e., a coverage area). At block 404, the transmitter establishes a connection with the one or more user equipment. In this regard, when a user operating one or more user equipment moves within the RF coverage range, the charging station can automatically connect to the user equipment without the need to conduct pairing. Various types of connection methods can be used, including Bluetooth low energy.

At block 406, the transmitter component can request from the one or more user equipment, voltage data correlating to a battery that is integral to the one or more user equipment. Without limitation, voltage data comprises the voltage of the battery, the maximum charge current that the battery can accept, battery impedance, and/or so forth. In various embodiments, the transmitter component can also request from the one or more user equipment charging protocol for the battery. The charging protocol can comprise factory preset protocols and/or customized protocol set by the user of the user equipment. At decision block 408, the charging station determines whether any charging parameters exist in order to charge the one or more connected user equipment in a predetermined order or method or to target the one or more user equipment. For example, the charging station can target devices operating in a power saver mode under given power plan options. If any charging parameters such as customized protocol exist (yes response from the decision block 408), the charging station targets the one or more user equipment for charging in accordance with the charging parameters as indicated in block 410. For example, the charging station can sort the one or more user equipment in order of priority for over-the-air charging. In various embodiments, the charging station can also target user equipment based on device type. For example, the charging station can target user equipment with low power appetite in order to increase efficiency. Additionally, if the charging station is fee based, the charging station can target user equipment with associated payment methods. Upon identifying the one or more user equipment to charge, the charging station, via its transmitter unit, transmits RF signals to the connected user equipment as indicated in block 412.

FIG. 5 is a flow diagram of an example process 500 for receiving predefined criteria for prioritizing user equipment for over-the-air charging from the perspective of one or more computing nodes that are configured to support or execute a remote device charging management application. At block 502, the computing nodes, via a device management module of the remote device charging management application, receives a user input comprising a device identification corresponding to one or more user equipment having a receiver component and a battery corresponding to voltage data in order to establish a connection between the user equipment and a charging station. The device identification can correlate with a user account that is associated with a plurality of user equipment and a plurality of users, depending upon embodiments. Additionally, the user account can be associated with one or more payment methods.

At block 504, the device management module receives predefined criteria for charging the user equipment associated with the device identification. The predefined criteria can include charging protocol, wherein the charging protocol can be factory preset protocol, a customized protocol, or any combination thereof. The charging protocol can comprise the voltage data and other relevant data for charging the user equipment. At block 506, a location services module of the remote device charging management application tracks real-time location of the connected user equipment using various location services techniques. In this way, the location services module can determine whether the user equipment is in a coverage area corresponding to one or more charging stations as indicated in decision block 508.

If the user equipment is not within the coverage area (no response from the decision block 508), the charging stations cannot serve the user equipment. If the user equipment is within the coverage area (yes response from the decision block 508), the logic module can instruct the charging stations to serve the user equipment by providing power transmission signals to the user equipment as indicated in block 510, whereby the receiver component of the user equipment can convert the signals to electrical power that can charge the battery. At block 512, the device management module can add, remove, and/or replace connected user equipment comprising receiver components. In this regard, device identification corresponding to the added, removed, and/or replaced user equipment can be automatically uploaded.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A user equipment comprising:
a battery;
a receiver component for receiving power transmission signals, the receiver component further configured to convert the power transmission signals into electrical power for charging the battery;
one or more processors;
a memory unit coupled to the one or more processors, the memory including a charging logic module that is executable by the one or more processors to:
determine a voltage range of the battery;
establish a communicative connection with a charging station, the user equipment being located within a coverage area of the charging station;
receive, from the charging station the power transmission signals within the voltage range of the battery.

2. The user equipment of claim 1, wherein the charging station is a first charging station that is configured to transmit first power transmission signals in a first coverage area, and wherein the charging logic module is further executable by the one or more processors to:
detect a second charging station that is configured to transmit second power transmission signals in a second coverage area.

3. The user equipment of claim 2, wherein the charging logic module is further executable by the one or more processors to:
selectively connect to the first charging station or the second charging station based on the strength of the first power transmission signals and the second power transmission signals at a location of the user equipment.

4. The user equipment of claim 1, wherein the second charging station coverage area partially overlaps with the first coverage area.

5. The user equipment of claim 1, wherein the charging logic module is further executable by the one or more processors to:
receive a priority indication from the charging station that prioritizes charging of the battery of the user equipment ahead of another user equipment that is located within the coverage area of the charging station.

6. The user equipment of claim 1, wherein the charging station can comprise a fee structure.

7. The user equipment of claim 1, wherein the charging logic module is further executable by the one or more processors to:
receive an indication from the charging station that manages simultaneous charging of the battery of the user equipment and another user equipment that is located within the coverage area of the charging station.

8. The user equipment of claim 1, wherein the charging logic module is further executable by the one or more processors to:
receive an indication from the charging station when the user equipment is located outside the coverage area of the charging station.

9. One or more non-transitory computer-readable media storing computer-executable instructions that upon execution cause one or more processors to perform acts comprising:
detecting a presence of one or more user equipment in a coverage area, the one or more user equipment associated with a device identification and comprising a receiver component for receiving power transmission signals;
establishing a connection to one more user equipment;
receiving a voltage range of a battery of the one or more user equipment; and
transmitting power transmission signals within the voltage range of the battery to serve the one or more user equipment, wherein the one or more user equipment converts the power transmission signals to electrical power for charging the battery.

10. The one or more non-transitory computer-readable media of claim 9, wherein the acts further comprise:
receiving charging protocol associated with the battery of the one or more user equipment.

11. The one or more non-transitory computer-readable media of claim 9, wherein the acts further comprise:
determining a real-time location of the one or more user equipment; and
if the one or more user equipment is not in the coverage area, denying transmission of power transmission signals to the one or more user equipment.

12. The one or more non-transitory computer-readable media of claim 9, wherein the one or more user equipment comprises a first user equipment and a second user equipment, further wherein the first user equipment and the second user equipment receive the power transmission signals concurrently.

13. The one or more non-transitory computer-readable media of claim 12, wherein the power transmission signals comprise a first power transmission signal and a second power transmission signal, further wherein the first user equipment receives the first power transmission signal and the second user equipment receives the second power transmission signal.

14. The one or more non-transitory computer-readable media of claim 13, wherein a voltage range of the first user equipment does not overlap a voltage range of the second user equipment.

15. The one or more non-transitory computer-readable media of claim 9, wherein the acts further comprise targeting the power transmission signals to at least one of the one or more user equipment based on the device identification.

16. A computer-implemented method, comprising the steps of:
receiving a user input comprising a device identification corresponding to one or more user equipment, the one or more user equipment having a receiver component and a battery corresponding to a voltage range;
identifying a charging station serving in a coverage area in which the one or more user equipment is located; and
determining power transmission signals to transmit to the one or more user equipment, via the charging station, based at least partially on the voltage range.

17. The computer-implemented method of claim 16, wherein the user input utilizes an identification correlating with a user account that is associated with a plurality of user equipment and a plurality of users.

18. The computer-implemented method of claim 16, further comprising the steps of:
receiving charging protocol associated with the battery of the one or more user equipment.

19. The computer-implemented method of claim 16, further comprising the steps of:
determining a real-time location of the one or more user equipment; and
if the one or more user equipment is not in the coverage area, identifying a second charging station service in a second coverage area in which the one or more user equipment is located.

20. The computer-implemented method of claim 18, further comprising the steps of:
selecting one or more charging options, wherein the one or more charging options are based on the charging protocol associated with the battery of the one or more user equipment.
